(19) United States
(12) Patent Application Publication
(10) Pub. No.: US 2021/0398168 A1
(43) Pub. Date: Dec. 23, 2021

(54) REAL-TIME INTELLIGENT ADVERTISEMENT DELIVERY METHOD AND SYSTEM BASED ON LICENSE PLATE INFORMATION REPORTING AND LICENSE PLATE RECOGNITION

(71) Applicant: SHANGHAI BIHU NETWORK TECHNOLOGY CO., LTD, Shanghai (CN)

(72) Inventor: Jianfeng WANG, Shanghai (CN)

(21) Appl. No.: 17/466,826

(22) Filed: Sep. 3, 2021

Related U.S. Application Data
(63) Continuation of application No. PCT/CN2019/103751, filed on Aug. 30, 2019.

(30) Foreign Application Priority Data
Mar. 4, 2019 (CN) 201910160263.1

(51) Int. Cl. G06Q 30/02; G06K 9/00; H04N 9/31; G06K 9/78; H04H 20/53; B60R 11/04; G05D 1/00; G09F 9/30; G09F 21/04

(52) U.S. Cl. CPC G06Q 30/0266; G06K 9/00791; H04N 9/31; G06K 9/78; H04H 20/53; B60R 2011/0001; G05D 1/0011; G09F 9/30; G09F 21/04; G06K 2209/15; B60R 11/04

(57) ABSTRACT

Provided is a real-time intelligent advertisement delivery method based on license plate information reporting and license plate recognition, wherein a rear vehicle is identified through recognition of a rear vehicle license plate number, and customized content delivery is performed on the vehicle from a front vehicle or surrounding vehicles/devices. Therefore, a personalized projection effect is realized.

### TECHNICAL FIELD

The present invention relates to a field of vehicle broadcast, in particular to a real-time intelligent advertisement delivery method based on license plate information reporting and license plate recognition.

### BACKGROUND

Vehicle broadcast technology has developed so far, although has achieved an effect of mobile broadcast, there is still no single-screen or multi-screen advertising technology for real-time dynamic regional adjustment and content customization of driving vehicles in the field until now. Particularly, due to the lack of personalized broadcasting scheme, the broadcasting content will thereby leading to features of chaotic broadcasting objects and no specific broadcast.

### SUMMARY

The present invention aims to overcome the above defects, providing a technology that can bring the outdoor media into an era of mobile intelligent delivery, as well as performs accurate, real-time and personalized advertisement delivery on mobile car screens, thereby greatly improving the effect of outdoor advertising.

The real-time intelligent advertisement delivery method based on license plate information reporting and license plate recognition, provided in the present invention, which is characterized in that a rear vehicle is identified through recognition of a rear vehicle license plate number, and customized content delivery is performed on the vehicle from a front vehicle or surrounding vehicles/devices.

Further, the real-time intelligent advertisement delivery method based on license plate information reporting and license plate recognition, provided in the present invention, is characterized in that the specific method is as follows:

S1. photographing and recognizing the license plate number of the rear vehicle;

S2. judging whether the rear vehicle is a target broadcasting vehicle;

when a judging result is “yes”, performing step S3;

when a judging result is “no”, repeat S1; that is, continuously recognizing the number of the rear vehicle until a target broadcasting vehicle is found. The target broadcasting vehicle generally refers to a vehicle that has customized a delivery service.

S3. filtering out a broadcasting content of the target broadcasting vehicle and performing the broadcast.

The broadcasting content is generally pre-set on the system. For example, a vehicle with a license plate A is delivered with a broadcasting content A. A vehicle with a license plate B is delivered with a broadcasting content B. Therefore, when a license plate is recognized, a specified broadcasting content can be directly invoked for playing.

Further, the real-time intelligent advertisement delivery method based on license plate information reporting and license plate recognition, provided in the present invention, is also characterized in further comprising steps:

S4. filtering online vehicles or online devices within a specified range, according to a current position of the target broadcasting vehicle,

herein, the said online vehicles refer to vehicles that can perform projection work under the platform;

herein the said online devices refer to projection screens or multimedia playing screens of fixed devices or facilities under the platform, as well as

S5. performing the broadcast of the broadcasting content said in the step S3 to the online vehicle or the online device filtered out in the step S4.

This step can be performed between the S2 and the S3, or after the S3. The purpose thereof is to make the periphery of the target vehicle in an advertised state.

Further, the real-time intelligent advertisement delivery method based on license plate information reporting and license plate recognition, provided in the present invention, is also characterized in further comprising steps:

S6. after a current vehicle starts broadcasting, continuously photographing and recognizing the license plate number of the rear vehicle;

S7. judging whether the license plate number is consistent with the license plate number obtained by the S1;

when a judging result is “yes”, continuing current playing and repeat the step S5;

when a judging result is “no”, stop the current playing and repeat the step S1.

The purpose of this step is to judge a vehicle condition of the rear vehicle in real time, and adjust delivering content when the rear vehicle changes, so that all rear vehicles can obtain the best personalized delivering content in real time.

Additionally, the present invention also provides a real-time intelligent advertisement delivery system based on license plate information reporting and license plate recognition, which is characterized in comprising an online vehicle and a remote control terminal;

wherein the online vehicle is equipped with a photographing device and a projection device;

the photographing device, the projection device and the remote control terminal are all provided with a communication module for realizing data interaction between each of the devices;

the photographing device is provided with a photographing module and a resolving module;

the photographing module obtains a photo of a license plate of a rear vehicle by a photographing manner;

the resolving module resolves out a license plate number of the rear vehicle according to the photo of the rear vehicle, and uploads the license plate number to the remote control terminal in a form of characters or numbers;

the remote control terminal is provided with an analysis module and an instruction module;

the analysis module analyzes whether the vehicle corresponding to the license plate number is a target vehicle, according to the license plate number;

when an analysis result is “yes”, the instruction module filters out a broadcasting content of the target vehicle, and sends an instruction to broadcast the broadcasting content to the online vehicle;

s the projection device is provided with a projection module;

after receiving the broadcasting instruction, the projection module performs a projection of the broadcasting content.

Further, the real-time intelligent advertisement delivery system based on license plate information reporting and license plate recognition, which is also characterized in that the online vehicle is also provided with a positioning module;

the positioning module locates a position of the vehicle, and sends positioning information of the vehicle to the remote control terminal.

Further, the real-time intelligent advertisement delivery system based on license plate information reporting and license plate recognition, which is also characterized in that the positioning module also locates a position of the rear vehicle, and sends positioning information of the rear vehicle to the remote control terminal.

The positioning information can be calculated according to a distance between the rear vehicle and the vehicle.

Further, the real-time intelligent advertisement delivery system based on license plate information reporting and license plate recognition, which is also characterized in that the analysis module also searches for other online vehicles or online devices under the system, within a specified range, according to the positioning information of the online vehicle or positioning information of the target vehicle;

the instruction module sends the instruction of broadcasting content to the other online vehicles or online devices, according to the filtered out broadcasting content.

Further, the real-time intelligent advertisement delivery system based on license plate information reporting and license plate recognition, which is also characterized in that the photographing device or the remote control terminal is also provided with an identification module;

the identification module judges a consistency of the license plate number obtained in real time;

the consistency judgment is whether the license plate number photographed at time T+1 is consistent with the license plate number photographed at time T;

when a result is “inconsistent”, the instruction module sends an instruction of “stop projection” to the current vehicle, meanwhile, the analysis module analyzes the license plate number photographed at the time T+1 again.

Further, the real-time intelligent advertisement delivery system based on license plate information reporting and license plate recognition, which is also characterized in further comprising a client terminal;

the client terminal is provided with a communication module and a delivery module;

the communication module realizes data interaction between each of the devices;

the delivery module updates/sends the target vehicle to be broadcasted and the broadcasting content to the remote control terminal.

### Functions and Effects of the Present Invention

The delivery technology of on-board mobile screen based on real-time cloud management according to the present invention: 1. by installing ultra-short focus projection devices in taxis, buses and online-booked cars, the windows (including rear window and side window) of the above vehicles may be turned into mobile screens through projection, LED/LCD and other technical means; 2. all vehicle projection devices are connected to a cloud terminal through 4G/5G or WiFi and other technical means for real-time communication with the cloud; 3. mobile terminals upload information to the cloud, and the cloud performs delivery of customized advertising content, according to the information, including vehicle location, corresponding time period, vehicle corresponding landmark, surrounding vehicles, surrounding people and other information, uploaded by vehicle devices; 4. the specific implementation method is that the cloud system pre-sets delivering rules in advance, and the vehicle projection device communicates with the cloud in real time during the driving process of the vehicle. Once the cloud delivering rules are triggered by factors such as vehicle location, or time period, or recognition based on front vehicle devices, the cloud sends a corresponding delivering instruction to the specific vehicle screen. At this time, the vehicle screen device invokes corresponding pictures that are downloaded from the cloud and stored locally for delivery, or directly downloads the pictures from the cloud for delivery.

The present invention can bring outdoor media into an era of mobile intelligent delivery, as well as carry out accurate, real-time and personalized advertising delivery on moving vehicle screens, which greatly improves the effect of outdoor advertising.

### BRIEF DESCRIPTION OF THE DRAWINGS

FIG. 1 shows an operation flow chart of the real-time intelligent advertisement delivery method based on license plate information reporting and license plate recognition according to the embodiment.

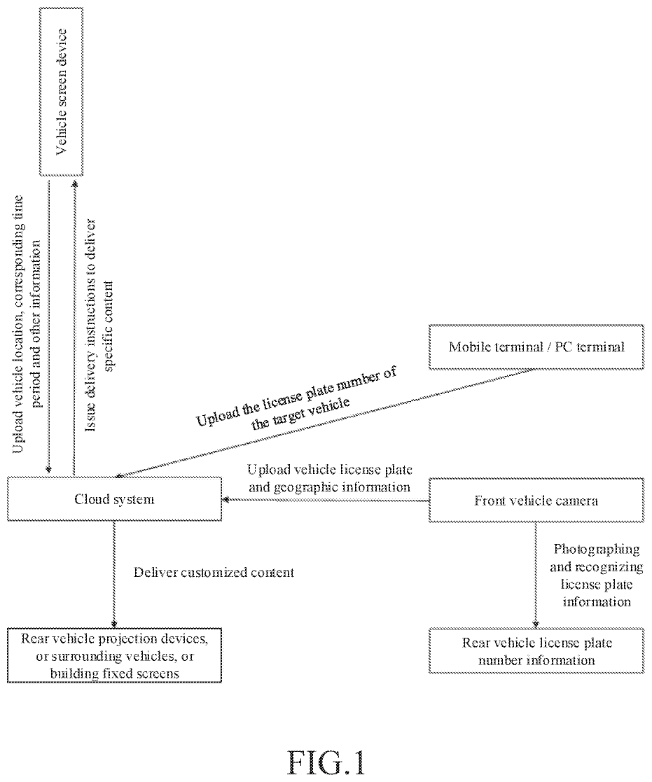

### DETAILED DESCRIPTION OF EMBODIMENTS

This embodiment provides a real-time intelligent advertisement delivery method based on license plate information reporting and license plate recognition. The purpose thereof is to identify whether a rear vehicle is the target advertisement object, through a recognition of the license plate number of the rear vehicle by the front vehicle. If the rear vehicle is the advertisement object, a customized content will be delivered to the rear vehicle by the front vehicle or a surrounding vehicle or a surrounding advertising device. Thus, the purpose of mobile playing, anytime playing and personalized playing is realized.

The specific method thereof is as follows:

S1. photographing and recognizing the license plate number of the rear vehicle;

S2. judging whether the rear vehicle is a target broadcasting vehicle;

when a judging result is “yes”, performing step S3;

when a judging result is “no”, repeat S1;

S3. filtering out a broadcasting content of the target broadcasting vehicle and performing the broadcast.

The system devices based on the above method comprise an online vehicle, a remote control terminal and a client terminal; wherein the online vehicle is equipped with a photographing device and a projection device.

The photographing device, the projection device, the client terminal and the remote control terminal are all provided with a communication module for realizing data interaction between each of the devices.

The photographing device is generally installed at the rear of the vehicle (such as a video camera or a photo camera provided at the location of the rear window, the rear panel and the rear portion of the vehicle). The photographing device is not only provided with a camera function, but also provided with digital recognition algorithm software, that is, a photographing module and a resolving module.

The photographing module obtains a photo of a license plate of the rear vehicle by a photographing manner. The photographing frequency can be set and adjusted arbitrarily, such as: 10 times per second, or once every 10 seconds, etc., which can be adjusted according to actual needs.

The resolving module is loaded with the algorithm software. The module resolves out a license plate number of the rear vehicle according to the photo of the rear vehicle, and uploads the license plate number to the remote control terminal in a machine-readable form such as characters or numbers.

The remote control terminal is provided with an analysis module and an instruction module.

The analysis module analyzes whether the vehicle corresponding to the license plate number is a target vehicle, according to the license plate number. The analysis process is generally to compare the license plate number with the license plate number stored in the system. For example, if a consistent number can be matched in the system, then the vehicle is determined to be the target vehicle.

When the analysis result is “yes”, the instruction module filters out a broadcasting content of the target vehicle, and sends an instruction to broadcast the broadcasting content to the online vehicle. The broadcasting content is generally stored in the system.

The projection device is generally installed behind the back cushion of the vehicle, and can perform multimedia information projection to the glass of the rear window, that is, provided with a projection module.

After receiving the broadcasting instruction, the projection module performs a projection of the broadcasting content. A client terminal is further comprised.

The client terminal is provided with a delivery module.

The delivery module updates/sends the target vehicle to be broadcasted and the broadcasting content to the remote control terminal.

In addition, in order to achieve greater advertising scope and advertising effect.

In this embodiment, the step S3 is followed by a step S4 and other steps, as follows:

S4. filtering online vehicles or online devices within a specified range, according to the current position of the target broadcasting vehicle. The online vehicles or online devices refer to vehicles or fixed roadside devices (such as multimedia playing devices/projection devices, etc.), which are owned by the system/platform.

S5. performing the broadcast of the broadcasting content said in the step S3 to the online vehicle or the online device filtered out in the step S4.

The device based on this method is:

a positioning module that is further provided with the online vehicle.

The positioning module locates a position of the vehicle, and sends positioning information of the vehicle to the remote control terminal.

In addition, the positioning module also locates a position of the rear vehicle, and sends positioning information of the rear vehicle to the remote control terminal.

The analysis module also searches for other online vehicles or online devices under the system, within a specified range (the specified range can be all devices within a radius of 100 meters with the current positioning information as the center), according to the positioning information of the online vehicle or positioning information of the target vehicle.

The instruction module sends the instruction of broadcasting content to the other online vehicles or online devices, according to the filtered out broadcasting content.

In addition, in order to avoid improper playing when the rear vehicle changes.

The present embodiment also comprises steps such as step S6.

S6. After the current vehicle starts broadcasting, continuously photographing and recognizing the license plate number of the rear vehicle;

S7. judging whether the license plate number is consistent with the license plate number obtained by the S1;

when a judging result is “yes”, continuing current playing and repeat the step S5;

when a judging result is “no”, stop the current playing and repeat the step S1.

The device based on this method is:

an identification module that is further provided with the photographing device or the remote control terminal.

The identification module judges the consistency of the license plate number obtained in real time; that is, whether the license plate number photographed at time T+1 is consistent with the license plate number photographed at time T.

When the result is “inconsistent”, the instruction module sends an instruction of “stop projection” to the current vehicle, meanwhile, the analysis module analyzes the license plate number photographed at the time T+1 again.

In this embodiment:

1. A camera is fixed outside the rear portion of the vehicle or on the rear window of the vehicle. The installed camera may photograph the rear vehicle behind the vehicle. The camera communicates with the cloud management system in real time through in-vehicle devices, or WiFi in the vehicle, or its own 4G/5G network.

2. The installed camera is embedded with an algorithm chip, which can recognize the license plate number of the rear vehicle from the photos of the rear vehicle, and upload the license plate number of the rear vehicle to the cloud management system in the form of numbers or characters.

3. The advertisement delivery system is logged in through mobile terminals such as mobile phones or computers, to report the license plate number of the target vehicle that needs advertisement delivery.

4. The target vehicle whose license plate number is reported can be recognized by vehicles equipped with a camera and connected to the delivery system, which are in front of the target vehicle, or surrounding outdoor screens.

5. The cloud management system may receive the license plate information of the rear vehicle photographed and recognized by the camera, and control an installed rear window screen for customized advertising delivery, according to the information.

6. The cloud management system may receive the license plate information of the rear vehicle photographed and recognized by the camera, and control the inside and outside screens of the surrounding vehicles, as well as the fixed screens of the surrounding buildings, which are connected to the cloud management system, for customized advertising delivery, according to the information.

7. After receiving the license plate information of the recognized rear vehicle returned by the camera, the cloud management system may perform a conditional comparison query between the license plate information and a database of the system or a third-party database, and control the screens connected to the cloud for real-time delivery of customized advertising content, according to the query results.

Those skilled in the art will appreciate that the various illustrative logic modules, circuits, and algorithm steps described in connection with the embodiments disclosed herein may be implemented as electronic hardware, computer software, or a combination of the two. In order to clearly explain the interchangeability of hardware and software, various illustrative components, frames, modules, circuits, and steps are generally described in the form of their functionality. Whether such functionality is implemented as hardware or software depends on the specific application and the design constraints imposed on the overall system. Technicians may implement the described functionality in different ways for each specific application, but such implementation decisions should not be interpreted as leading to departure from the scope of the present invention.

The various illustrative logic modules and circuits described in connection with the embodiments disclosed herein may be implemented or executed by a general-purpose processor, a digital signal processor (DSP), an application specific integrated circuit (ASIC), a field programmable gate array (FPGA) or other programmable logic devices, discrete gate or transistor logic, discrete hardware components, or any combination thereof, which is designed to perform the function described herein. The general-purpose processor may be a microprocessor, but in an alternative, the processor may be any conventional processor, controller, microcontroller, or state machine. The processor may also be implemented as a combination of computing devices, such as a combination of DSP and microprocessor, a plurality of microprocessors, one or more microprocessors cooperating with a DSP core, or any other such configuration.

The steps of a method or algorithm described in connection with the embodiments disclosed herein may be embodied directly in hardware, in a software module executed by a processor, or in a combination of the two. The software module may reside in RAM memory, flash memory, ROM memory, EPROM memory, EEPROM memory, register, hard disk, removable disk, CD-ROM, or any other form of storage medium known in the art. An exemplary storage medium is coupled to the processor so that the processor can read and write information from/to the storage medium.

1. A real-time intelligent advertisement delivery method based on license plate information reporting and license plate recognition, wherein a rear vehicle is identified through recognition of a rear vehicle license plate number, and customized content delivery is performed on the vehicle from a front vehicle or surrounding vehicles/devices.

2. The real-time intelligent advertisement delivery method based on license plate information reporting and license plate recognition of claim 1, wherein the specific method is as follows:
S1. photographing and recognizing the license plate number of the rear vehicle;
S2. judging whether the rear vehicle is a target broadcasting vehicle;
when a judging result is “yes”, performing step S3;
when a judging result is “no”, repeat S1;
S3. filtering out a broadcasting content of the target broadcasting vehicle and performing the broadcast.

3. The real-time intelligent advertisement delivery method based on license plate information reporting and license plate recognition of claim 2, further comprising steps:
S4. filtering online vehicles or online devices within a specified range, according to a current position of the target broadcasting vehicle;
S5. performing the broadcast of the broadcasting content said in the step S3 to the online vehicle or the online device filtered out in the step S4.

4. The real-time intelligent advertisement delivery method based on license plate information reporting and license plate recognition of claim 2, further comprising steps:
S6. after a current vehicle starts broadcasting, continuously photographing and recognizing the license plate number of the rear vehicle;
S7. judging whether the license plate number is consistent with the license plate number obtained by the S1;
when a judging result is “yes”, continuing current playing and repeating the step S5;
when a judging result is “no”, stop the current playing and repeating the step S1.

5. A real-time intelligent advertisement delivery system based on license plate information reporting and license plate recognition, comprising an online vehicle and a remote control terminal;
wherein the online vehicle is equipped with a photographing device and a projection device;
the photographing device, the projection device and the remote control terminal are all provided with a communication module for realizing data interaction between each of the devices;
the photographing device is provided with a photographing module and a resolving module;
the photographing module obtains a photo of a license plate of a rear vehicle by a photographing manner;
the resolving module resolves out a license plate number of the rear vehicle according to the photo of the rear vehicle, and uploads the license plate number to the remote control terminal in a form of characters or numbers;
the remote control terminal is provided with an analysis module and an instruction module;
the analysis module analyzes whether the vehicle corresponding to the license plate number is a target vehicle, according to the license plate number;
when an analysis result is “yes”, the instruction module filters out a broadcasting content of the target vehicle, and sends an instruction to broadcast the broadcasting content to the online vehicle;
the projection device is provided with a projection module;
after receiving the broadcasting instruction, the projection module performs a projection of the broadcasting content.

6. The real-time intelligent advertisement delivery system based on license plate information reporting and license plate recognition of claim 5, wherein
the online vehicle is also provided with a positioning module;
the positioning module locates a position of the vehicle, and sends positioning information of the vehicle to the remote control terminal.

7. The real-time intelligent advertisement delivery system based on license plate information reporting and license plate recognition of claim 6, wherein
the positioning module also locates a position of the rear vehicle, and sends positioning information of the rear vehicle to the remote control terminal.

8. The real-time intelligent advertisement delivery system based on license plate information reporting and license plate recognition of claim 6, wherein
the analysis module also searches for other online vehicles or online devices under the system, within a specified range, according to the positioning information of the online vehicle or positioning information of the target vehicle;
the instruction module sends the instruction of broadcasting content to the other online vehicles or online devices, according to the filtered out broadcasting content.

9. The real-time intelligent advertisement delivery system based on license plate information reporting and license plate recognition of claim 5, wherein
the photographing device or the remote control terminal is also provided with an identification module;
the identification module judges a consistency of the license plate number obtained in real time;
the consistency judgment is whether the license plate number photographed at time T+1 is consistent with the license plate number photographed at time T;
when a result is “inconsistent”, the instruction module sends an instruction of “stop projection” to the current vehicle, meanwhile, the analysis module analyzes the license plate number photographed at the time T+1 again.

10. The real-time intelligent advertisement delivery system based on license plate information reporting and license plate recognition of claim 5, further comprising:
a client terminal;
the client terminal is provided with a communication module and a delivery module;
the communication module realizes data interaction between each of the devices;
the delivery module updates/sends the target vehicle to be broadcasted and the broadcasting content to the remote control terminal.
